(19) United States
(12) Patent Application Publication
(10) Pub. No.: US 2007/0097445 A1
(43) Pub. Date: May 3, 2007

(54) Printing system, access source counting system, and program for printing system

(75) Inventors: Kazunori Tachi, Inazawa (JP); Satoshi Watanabe, Kasugai (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, NAGOYA (JP)

(21) Appl. No.: 11/586,523

(22) Filed: Oct. 26, 2006

(30) Foreign Application Priority Data
Oct. 31, 2005 (JP) 2005-316723

(51) Int. Cl. H04N 1/40

(52) U.S. Cl. 358/3.28

(57) ABSTRACT

There is provided a printing system, comprising a detection unit configured to search first data to detect link address information representing a link target address linked to second data, a storage unit that stores identification information identifying the printing system, an image code generation unit configured to generate an image code representing link information containing the link address information detected by the detection unit and the identification information obtained from the storage unit, and a print control unit configured to print the image code generated by the image code generation unit together with an image corresponding to the first data.

### CROSS-REFERENCE TO RELATED APPLICATION

This application claims priority under 35 U.S.C. §119 from Japanese Patent Application No. 2005-316723, filed on Oct. 31, 2005. The entire subject matter of the application is incorporated herein by reference.

### BACKGROUND

1. Technical Field

Aspects of the present invention relate to a printing system capable of printing contents provided on a network such that an image code is added to the contents.

2. Related Art

Recently, many companies post advertisements of their products or services on many web pages, targeting the products or services at home users who use a user's device to browse the Internet (i.e., the advertisements) from their homes. There are web pages configured to have advertisements containing image codes (e.g., a 2D (two-dimensional) code or a barcode) linked to there respective link targets (i.e., advertisement pages) so that a user can reach the link target by reading the printed web page through the user's device.

By monitoring access from the user who operated the user's device to read the image code and to access a company's web site in accordance with the read image code, a server of the company's web site is able to know which image code causes the user's device to access the company's web site and to evaluate the affect of the advertisements by counting the access number of access based on the image code. An example of such a system is disclosed in Japanese Patent Provisional Publication No. 2002-111909 (hereafter, referred to as JP 2002-111909A).

Because the server of the company's web site is able to evaluate the effect of the advertisement only if the access from the user is caused based on the image code read by the user's device, the server is not able to evaluate the effect of the advertisements if the image code is not contained in the web page printed by the user's device.

The system disclosed in JP 2002-111909A further has a drawback that the image code does not contain information concerning a person who printed and distributed the web page including the advertisements. Therefore, the server of the company's web site is not able to identify the user (or the user's device) based on the access from the user, although the server is able to judge whether access from the user is based on the printed image code.

### SUMMARY

Aspects of the present invention are advantageous in that a printing system capable of capable of notifying a link target contained in printed contents of information identifying the printing system which printed the contents is provided.

### BRIEF DESCRIPTION OF THE ACCOMPANYING DRAWINGS

FIG. 1 is a block diagram of a network system according to an embodiment of the invention.

FIG. 2 is a flowchart illustrating a main process to be executed by a multifunction peripheral provided in the network system shown in FIG. 1.

FIGS. 3 and 4 show a flowchart of a printing process to be executed by the multifunction peripheral.

FIGS. 5A to 5D illustrate examples of screens generated in the printing process by the multifunction peripheral.

FIG. 6A shows an example of a printed image of print target data in which two-dimensional codes are added to link information.

FIG. 6B shows another example of a printed image of print target data in which two-dimensional codes are added to link information.

FIG. 7 is a flowchart illustrating a scanner integration information input process executed by the multifunction peripheral.

FIG. 8 is a flowchart illustrating a counting process.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

According to an aspect of the invention, there is provided a printing system, comprising a detection unit configured to search first data to detect link address information representing a link target address linked to second data, a storage unit that stores identification information identifying the printing system, an image code generation unit configured to generate an image code representing link information containing the link address information detected by the detection unit and the identification information obtained from the storage unit, and a print control unit configured to print the image code generated by the image code generation unit together with an image corresponding to the first data.

With this configuration, it is possible to print the image corresponding to the first data while adding the image code containing link information (including the link address information and identification information identifying the printing system) to the image corresponding to the first data. The image code can be read by an image reading unit (e.g., a scanner). A device which has a printing function in the printing system may be a multifunction peripheral having multiple functions, a facsimile device or a printer. The printing system may be formed by more than one device. For example, the printing system may be formed by an information processing device and a printing device which are communicatably connected to each other through a network.

In at least one aspect, the print control unit prints the image code and the image of the first data such that the image code is arranged alongside the link address information.

In at least one aspect, the link address information in the first data includes a plurality of link target addresses linked to different types of second data, and the image code generation unit generates a plurality of image codes respectively corresponding to a plurality of types of link information which respectively contain the plurality of link target addresses and the identification information.

In at least one aspect, the print control unit prints the image codes and the image of the first data such that the image codes are arranged in a cluster.

According to another aspect of the invention, there is provided a printing system, which comprises a detection unit configured to search first data to detect link address information representing a link target address linked to second data, a storage unit that stores identification information identifying a user of the printing system, an image code generation unit configured to generate an image code representing link information containing the link address information detected by the detection unit and the identification information obtained from the storage unit, and a print control unit configured to print the image code generated by the image code generation unit together with an image corresponding to the first data.

With this configuration, it is possible to print the image corresponding to the first data while adding the image code containing link information (including the link address information and identification information identifying the user of the printing system) to the image corresponding to the first data.

According to another aspect of the invention, there is provided a printing system, which comprises an access source counting system comprising a printing system; and a server that provides contents to the printing system through a network. The printing system comprises a detection unit configured to search first data to detect link address information representing a link target address linked to second data, a storage unit that stores identification information identifying the printing system, an image code generation unit configured to generate an image code representing link information containing the link address information detected by the detection unit and the identification information obtained from the storage unit, a print control unit configured to print the image code generated by the image code generation unit together with an image corresponding to the first data, a reading unit configured to read the code mage from a printing medium on which the image corresponding to the first data and the image code are printed, a link information acquisition unit configured to acquire the link information from the image code read by the reading unit, an accessing unit configured to access the link target address in accordance with the link information acquired by the link information acquisition unit, and an identification information transmission unit configured to transmit the identification information to the access target address in response to access to the link target address by the accessing unit. Further, the server comprises an identification information reception unit configured to receive the identification information transmitted from the identification information transmission unit, and a content providing unit configured to provide contents in accordance with the access from the accessing unit of the printing system.

With this configuration, it is possible to print the image code containing the link target information and the identification information identifying the printing system, to read the image code, and to access the link target in accordance with the image code.

In at least one aspect, the server further comprises a counting unit configured to count the number of accesses from the printing system in accordance with receipt of the identification information from the printing system.

According to another aspect of the invention, there is provided a printing system, which comprises an access source counting system comprising a printing system; and a server that provides contents to the printing system through a network. The printing system comprises a detection unit configured to search first data to detect link address information representing a link target address linked to second data, a storage unit that stores identification information identifying a user of the printing system, an image code generation unit configured to generate an image code representing link information containing the link address information detected by the detection unit and the identification information obtained from the storage unit, a print control unit configured to print the image code generated by the image code generation unit together with an image corresponding to the first data, a reading unit configured to read the code mage from a printing medium on which the image corresponding to the first data and the image code are printed, a link information acquisition unit configured to acquire the link information from the image code read by the reading unit, an accessing unit configured to access the link target address in accordance with the link information acquired by the link information acquisition unit, and an identification information transmission unit configured to transmit the identification information to the access target address in response to access to the link target address by the accessing unit. Further, the server comprises an identification information reception unit configured to receive the identification information transmitted from the identification information transmission unit, and a content providing unit configured to provide contents in accordance with the access from the accessing unit of the printing system.

With this configuration, it is possible to print the image code containing the link target information and the identification information identifying the user of the printing system, to read the image code, and to access the link target in accordance with the image code.

According to another aspect of the invention, there is provided a computer readable medium having computer readable instructions stored thereon, which, when executed by a computer, are configured to search first data to detect link address information representing a link target address linked to second data, to store identification information identifying the printing system, to generate an image code representing link information containing the detected link address information and the stored identification information, and to control a print unit to print the image code together with an image corresponding to the first data.

With this configuration, it is possible to print the image corresponding to the first data while adding the image code containing link information (including the link address information and identification information identifying the printing system) to the image corresponding to the first data.

According to another aspect of the invention, there is provided a computer readable medium having computer readable instructions stored thereon, which, when executed by a computer, are configured to search first data to detect link address information representing a link target address linked to second data, to store identification information identifying a user of the printing system, to generate an image code representing link information containing the detected link address information and the stored identification information, and to control a print unit to print the image code together with an image corresponding to the first data.

With this configuration, it is possible to print the image corresponding to the first data while adding the image code containing link information (including the link address information and identification information identifying the user of the printing system) to the image corresponding to the first data.

### Embodiment

Hereafter, an embodiment according to the invention will be described with reference to the accompanying drawings.

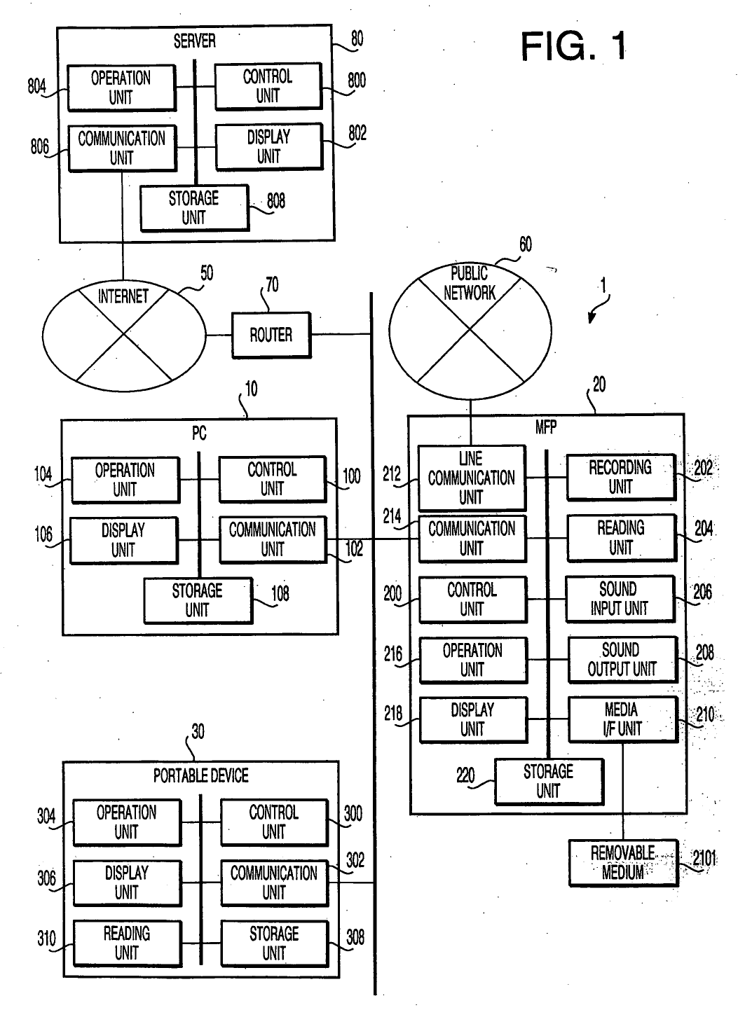

FIG. 1 is a block diagram of a network system 1 according to an embodiment of the invention. The network system 1 includes a PC (personal computer) 10 functioning as an information processing device having a management function of information, an MFP (multifunction peripheral) 20 capable of providing more than two functions, and a portable device 30 having a function of reading a two-dimensional code (an image code). The PC 10, the MFP 20 and the portable device 30 are communicatably connected to each other via a network 40.

The PC 10 includes a control unit 100 controlling functions of the PC 10, a communication unit 102 controlling data communication through the network 40, an operation unit 104 to be operated by a user of the PC 10, a display unit 106 on which information is displayed, and a storage unit 108 formed of, for example, an HDD. The control unit 100 includes a CPU, a RAM, and a ROM (not shown), and the CPU executes various programs stored in the ROM.

The MFP 20 includes a control unit 200 controlling functions of the MFP 20, a recording unit 202 configured to generate images, a reading unit 204 configured to read images, a sound input unit 206 having a microphone, a sound output unit 208 having a speaker, a media interface unit 210 to which a removable medium 2101 is attached, and a storage unit 220 (e.g., an HDD or a nonvolatile RAM) storing data transmitted from the PC or an external server, information identifying a user, and a two-dimensional code.

The MFP 20 further includes a line communication unit 212 controlling a public network 60, a communication unit 214 controlling data communication through the network 40, an operation unit 216 to be operated by a user of the MFP 20, and a display unit 218 on which information is displayed. The MFP 20 has a function of detecting a one-dimensional code such as a bar code or a two-dimensional code such as a QR code™ from an image read by the reading unit 204. The MFP 20 is able to access a server 80 or the PC 10 based on the detected codes.

The portable device 30 includes a control unit 300 controlling functions of the portable device 300, a reading unit 310 configured to capture an image (e.g., a camera), a storage unit 308 (e.g., an HD Dot a non-volatile memory), a communication unit 302 controlling data communication through the network 40, an operation unit 304 to be operated by a user, and a display unit 306 on which information is displayed. The control unit 300 includes a CPU, a ROM and a RAM. In FIG. 1, the portable device 30 is connected to the network 40 via the communication unit 302. The portable device 30 is also able to communicate with a server 80 and the PC 10 through wireless communication.

Each of the PC 10, the MFP 20 and the portable device 30 is connected to an external network (i.e., the Internet 50) through a router 70, and is able to communicate with the server 80 which is connected to the Internet 50. That is, each of the PC 10, the MFP 20 and the portable device 30 is able to browse web pages or contents on the server 80. Although in FIG. 1 only one server 80 is illustrated; however, more than two servers may be provided in the network system 1.

The server 80 includes a control unit 800 controlling functions of the server 80, a communication unit 802 controlling data communication through the Internet 50, an operation unit 804 to be operated by a user (or an administrator) of the server 80, a display unit 802 on which information is displayed, and a storage unit 808 (e.g., an HDD). In the storage unit 808, contents such as web pages to be provided for a client (e.g., the PC 10, the MFP 20, or the portable device 30) in response to a request from the client are stored.

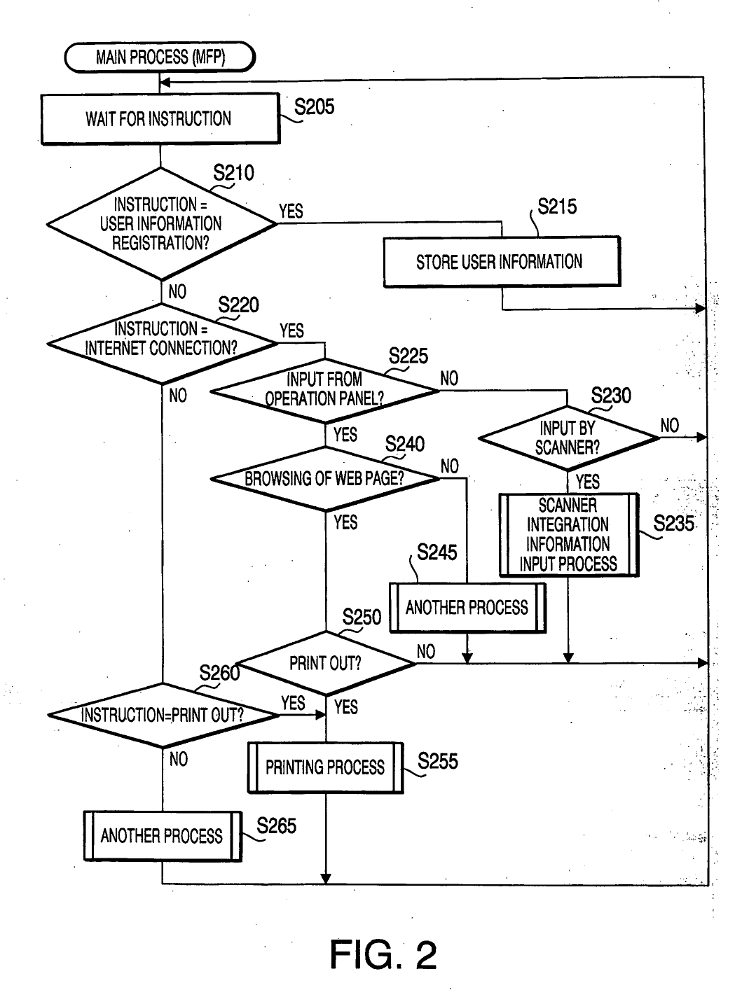

Hereafter, processing as a print system implemented in the network system 1 is described. FIG. 2 is a flowchart illustrating a main process to be executed under control of the control unit 200 of the MFP 20. The main process shown in FIG. 2 is executed by the CPU in the control unit 200 in accordance with a program stored in the ROM in the control unit 200.

First, the control unit 200 waits until an instruction, which is inputted by a user through the operation unit 216 or is externally inputted from the PC 10, is inputted (step S205). If an instruction is inputted, control proceeds to step S210. In step S210, the control unit 200 judges whether the instruction is an instruction for registering user information of the MFP 20.

If the instruction is an instruction for registering user information (S210: YES), control proceeds to step S215 where user information inputted through the operation unit 216 of the MFP 20 or externally inputted from the PC 10 is stored in the storage unit 220. As described in detail later, the user information is used to identify a printing system which has printed contents if link information is contained in the contents in a printing process. After step S215 is finished, control returns to step S205 to wait until an instruction instructing execution of a process is inputted.

The user information means identification information identifying a user, a device (e.g., the MFP 20), or a printing system.

If the instruction is not an instruction for registering user information (S210: NO), control proceeds to step S220 where the control unit 200 judges whether the instruction is an instruction for executing connection to the Internet. The connection to the Internet is achieved by the MFP 20 alone. If the instruction is an instruction for executing connection to the Internet (S220: YES), the control unit 200 judges whether an access target is directly inputted from the operation unit 216 as a URL (Uniform Resource Locator) (step S225).

If the access target is not inputted directly from the operation unit 216 (S225: NO), control proceeds to step S230 where the control unit 200 judges whether an access target is inputted through the reading unit 204 which reads a two-dimensional code printed on a print medium as the access target.

If the access target is inputted as the two dimensional code through the reading unit 204 (S230: YES), a scanner integration information input process which is described later is executed (step S235). If the access target is not inputted as the two dimensional code through the reading unit 204 (S230: NO), control returns to step S205 since in this case the instruction in step S220 does not correspond to an access target. Returning to step S205 may caused after a predetermined time has elapsed or when a cancel button provided on the operation unit 216 is pressed, so that a state where the MFP 2 is in a standby state for waiting a URL input and is unable to execute another process can be prevented from continuing when no user input is received for a certain time period.

If the access target is inputted directly from the operation unit 216 (S225: YES), control proceeds to step S240 where the control unit 200 judges whether the access target specified by the URL corresponds to a web page. If the access target does not correspond to a web page (S240: NO), the control unit 200 executes anther process (step S245). For example, in step S245, update of firmware, upload of data, etc. requiring connection to the Internet are performed. After step S245 is finished, control returns to step S205 to wait until an instruction is inputted.

If the instruction corresponds to browsing of a web page (S240: YES), control proceeds to step S250 where the control unit 200 judges whether the web page needs to be printed. The judgment in step S250 is conducted in accordance with a user input through the operation unit 216. If the web page do not need to be printed (S250: NO), control returns to step S205 to wait until an instruction is inputted.

If the web page needs to be printed (S250: YES), a printing process which is described in detail later is executed in step S255. After step S255 is finished, control returns to step S205 to wait until an instruction is inputted.

If the instruction inputted in step S210 does not correspond to user registration and connection to the Internet (S220: NO), the control unit 200 judges whether the instruction inputted in step S210 is a print instruction (step S260). If the instruction inputted in step S210 is a print instruction (S260: YES), control proceeds to step S255 to execute the printing process. An representative example of a print instruction is a print command from the PC 10.

If the instruction inputted in step S210 is not a print instruction (S260: NO), control proceeds to step S265 where another process is executed. In step S265, one of processes other than the process for user registration, the process for connection to the Internet and the printing process is executed. For example, in step S265, one of processes for a telephone communication and data reading/writing from/to the removable medium 2101 is executed. After step S265 is finished, control returns to step S205 to wait until an instruction is inputted.

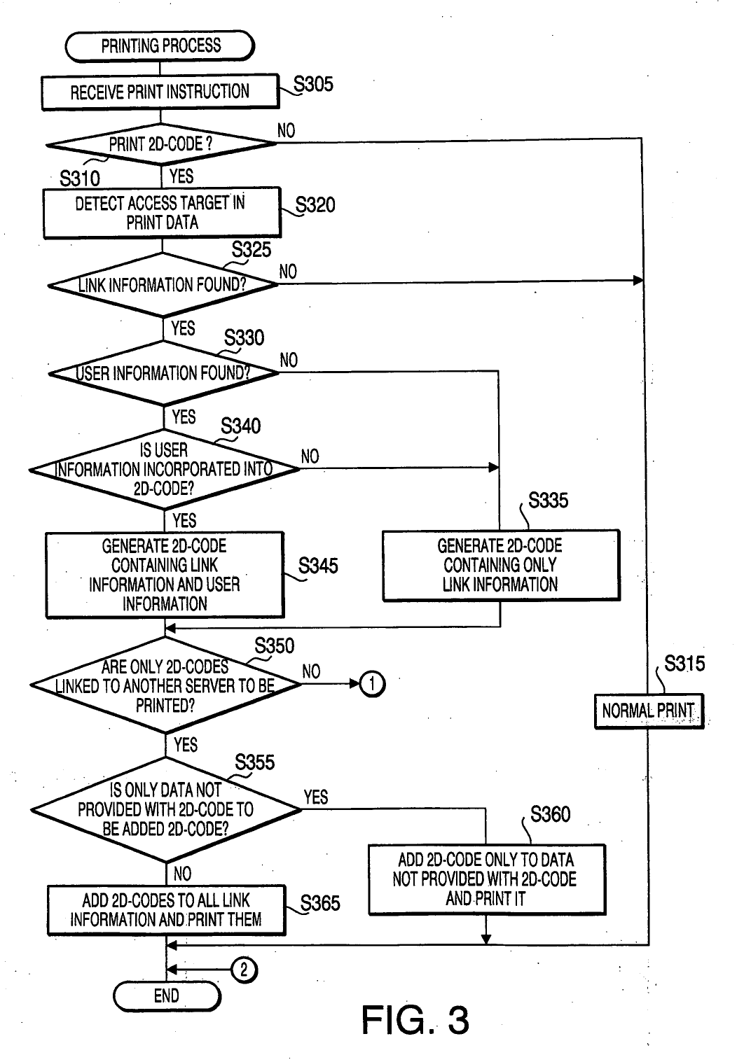

FIGS. 3 and 4 show a flowchart of the printing process to be executed under control of the control unit 200 of the MFP 20. In the printing process, link information is added to contents directly obtained from the server 80, data corresponding to contents transferred from the PC 10 or the portable device 30, or data generated by the PC 10 or the portable device 30, and the data (contents) to which the link information is added is printed.

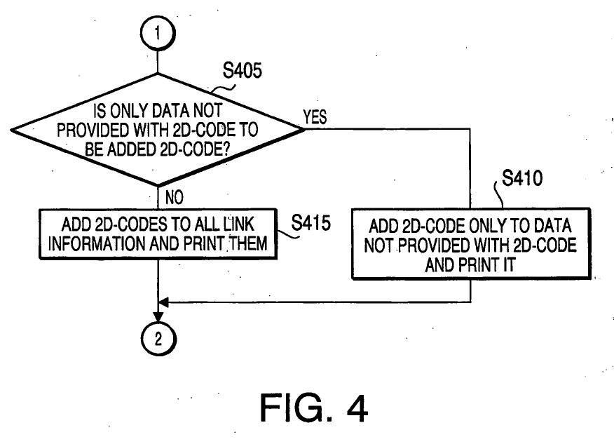

First, the control unit 200 receives a print instruction in step S305. Then, the control unit 200 displays a screen shown in FIG. 5A on the display nit 218 to request a user to determine whether a two-dimensional code containing access target information is to be printed together with print target data, and waits for a user input (step S310). If the two-dimensional code is not to be printed (i.e., the user selects an item “NO” in the screen shown in FIG. 5A) (S310: NO), control proceeds to step S315 where a normal print process is executed. Then, the printing process terminates.

As shown in FIG. 5A, the screen includes a question message “Do you print a two-dimensional code?”, and is configured to allow the user to select one the items “YES” and “NO” by using a cursor key of the operation unit 216.

If the two-dimensional code is to be printed (i.e., the user selects an item “YES” in the screen shown in FIG. 5A) (S310: YES), the control unit 200 operates to detect link information in the print target data (step S320). The control unit 200 is able to detect link information, for example, by detecting an item indicating link information in HTML (HyperText Markup Language) data if the control unit 200 prints a web page which is displayed based on the HTML data. For example, link information is indicated in HTML data by an expression “<a href=http://www.∘∘∘∘.com/”>”. In this case, “http://www.∘∘∘∘.com” indicates a link URL.

Next, in step S325, the control unit 200 judges whether link information is contained in print target data. If the link information is not contained in the print target data (S325: NO), control proceeds to step S315 where a normal print process is executed without printing the two-dimensional code (link information) because in this case there is no necessity to generate the two-dimensional information (oink information). Then, the printing process terminates.

If link information is contained in the print target data (S325: YES), control proceeds to step S330 where the control unit 200 judges whether user information is stored in the storage unit 220 by steps S210 and S215 in the main process of the MFP 20. If the user information is not registered (S330: NO), the control unit 200 starts to generate a two-dimensional code containing only the link information detected in step S320 (step S335). Then, control proceeds to step S350.

If the user information is not registered (S330: YES), control proceeds to step S340 where the control unit 200 judges whether the user information is to be incorporated into a two-dimensional code containing link information. If the user information is not to be incorporated into a two-dimensional code containing link information (S340: NO), the control unit 200 starts to generate a two-dimensional code containing only the link information (step S335). Then, control proceeds to step S350. The judgment in step S340 is conducted in accordance with a user selection through a screen shown in FIG. 5B which is displayed on the display unit 218 and represents a question message “Should user information be incorporated?”. The user is able to select one of items “YES” and “NO” on the screen shown in FIG. 5B by operating a cursor key on the operation unit 216.

If the user information is to be incorporated into a two-dimensional code containing link information (S340: YES), the control unit 200 starts to generate a two-dimensional code containing the user information and the link information (step S345). Then, control proceeds to step S350.

Since the link information and the user information are contained in the two-dimensional code generated in step S345, it is possible to easily access a destination device by reading the two-dimensional code and to notify an access target of information on the user who printed the two-dimensional code. In steps from step S350, the control unit 200 determines how to print the two-dimensional code generated as mentioned above, in accordance with various criterion. Since each of steps S335 and S345 is a step for starting generation of the two-dimensional code, the control unit 200 is able to execute steps from step S350 while generating the two-dimensional code. Such a configuration makes it possible to reduce a processing time of the entire printing process.

In step S350, the control unit 200 judges whether the two dimensional code is to be printed only if the server from which the print target data is obtained and the server specified by the link information are different from each other. If the two dimensional code is not to be printed only if the server from which the print target data is obtained and the server specified by the link information are different from each other (i.e., if the two-dimensional code is to be printed regardless of a link target) (S350: NO), control proceeds to step S405 (see FIG. 4). In this case, the two-dimensional code can be printed regardless of a link target server.

The judgment in step S350 is conducted in accordance with a user selection through a screen shown in FIG. 5C which is displayed on the display unit 218 and represents a question message “Should only a two-dimensional code for another server be printed?”. The user is able to select one of items “YES” and “NO” on the screen shown in FIG. 5C by operating the cursor key on the operation unit 216.

More specifically, in step S350, the control unit 200 judges that the link target server and the server from which the print target data is obtained are equal to each other if a domain name part of a URL of the link target detected in step S320 and a domain name part of a URL of the server from which the print target data is obtained are equal to each other. If these domain name parts are not equal to each other, the control unit 200 judges that the link target server and the server from which the print target data is obtained are different from each other.

In step S405, the control unit 200 judges whether a two-dimensional code is to be added to link information to which a two-dimensional code has already added in the print target data. The judgment in step S405 is conducted in accordance with a user selection through a screen shown in FIG. 5D which is displayed on the display unit 218 and represents a question message “Should only link information to which a two-dimensional code is not added be printed?”. The user is able to select one of items “YES” and “NO” on the screen shown in FIG. 5D by operating the cursor key on the operation unit 216.

If a two-dimensional code is to be added only to link information to which a two-dimensional code has not been added in the print target data (S405: YES), control proceeds to step S410 where the control unit 200 adds the two-dimensional code generated in step S335 or S345 only to the link information to which a two-dimensional code has not been added and prints the print target data. By this configuration, it is possible to print only the print target data to which a two-dimensional data has not been added regardless of a link target server. Such a configuration makes it possible to prevent a two-dimensional code from being printed redundantly.

If a two-dimensional code is to be added to link information to which a two-dimensional code has been added in the print target data (S405: NO), control proceeds to step S415 where the control unit 200 adds the two-dimensional code generated in step S335 or S345 to all the link information in the print target data and prints the print target data. By this configuration, it is possible to add the two-dimensional code to the print target data even if two-dimensional codes have been already added to the print target data, regardless of a link target server. Such a configuration makes it possible to add a newly generated two-dimensional code to the print target data even if two-dimensional codes which have already been added to the print target data are not recognizable in regard to resolution. Therefore, accessing to a link target can be securely attained even if the two-dimensional code already added to the print target data can not be printed out in an appropriate resolution.

The control unit 200 is able to judge whether a two-dimensional code is contained in the print target data, for example, by only extracting an image (e.g., a file having an extension of gif, jpg or bmp) from HTML data and executing a program for reading a two-dimensional code as image data if the print target data is formed of HTML data. By this configuration, the control unit 200 is able to detect the two-dimensional code from the print target data, and to judge that the print data is not provided with a two dimensional code or a two-dimensional code in the print target data is not recognizable if the control unit 200 is not detect a two-dimensional code in the print target data. It is also possible to judge whether a two-dimensional code is contained in the print target data by imaging the entire web page and executing a program configured to read a two-dimensional code.

If the print target data is generated by the PC 10 or the portable device 30, there is no server from which the print target data is obtained. Therefore, in this case, the judgment result in step S350 is “NO”.

If the two dimensional code is to be printed only if the server from which the print target data is obtained and the server specified by the link information are different from each other (S350: YES), control proceeds to step S355. In this case, it is possible to add a two-dimensional code only if a access target is different from the server from which the print target data is obtained.

In step S355, the control unit 200 judges whether a two-dimensional code is to be added to link information to which a two-dimensional code has already added in the print target data. If a two-dimensional code is to be added only to link information to which a two-dimensional code has not been added in the print target data (S355: YES), control proceeds to step S360 where the control unit 200 adds the two-dimensional code only to the link information to which a two-dimensional code has not been added and prints the print target data. By this configuration, it is possible to print the print target data to which a two-dimensional data has not been added only if a server specified by the link information is different from the server from which the print target date is obtained.

It is possible to prevent two-dimensional code from excessively added to the print target data if a link target address and a link source address represent the same server. Such a configuration makes it possible to prevent a two-dimensional code from being printed redundantly.

If a two-dimensional code is to be added to link information to which a two-dimensional code has been added in the print target data (S355: NO), control proceeds to step S365 where the control unit 200 adds the two-dimensional code to all the link information in the print target data and prints the print target data.

By this configuration, it is possible to add the two-dimensional code to the print target data even if two-dimensional codes have been already added to the print target data and a link target server specified by the link information is different from the server from which the print target data is obtained. Such a configuration makes it possible to add a newly generated two-dimensional code to the print target data even if two-dimensional codes which have already been added to the print target data are not recognizable in regard to resolution.

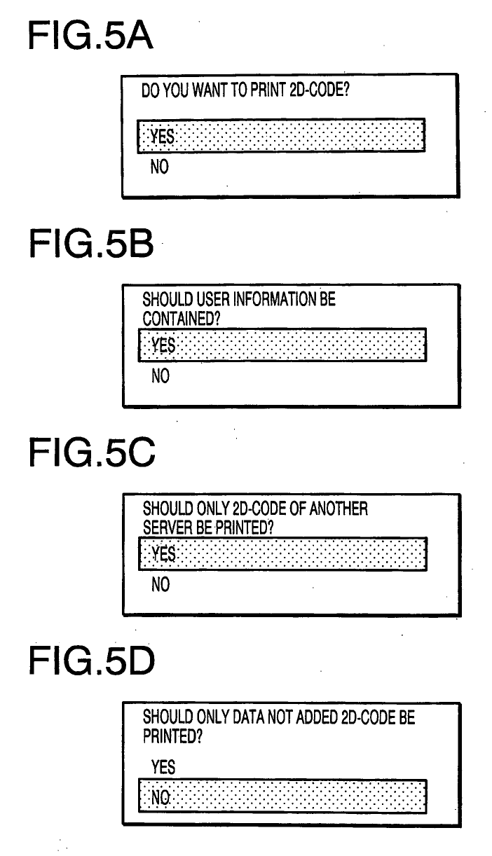

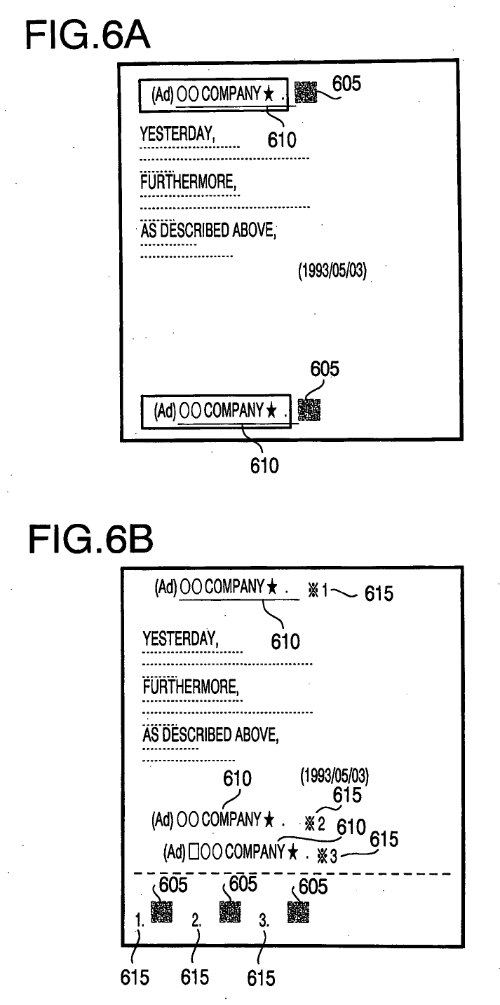

FIG. 6A shows an example of a printed image of the print target data in which two-dimensional codes 605 are added to link information 610. By printing the print target data such that the two-dimensional code 605 is placed alongside the link information 610 as shown in FIG. 6A, the user is able to easily recognize the relationship between the two dimensional code 605 and the link information 610.

FIG. 6B shows another example of a printed image of the print target data in which two-dimensional codes 605 are added to link information 610. By printing the print target data such that the two-dimensional codes are arranged in a cluster as shown in FIG. 6B, the user is able to comfortably read the printed image because in this case the original style of the print target data is maintained.

By assigning the same number or the same symbol to the link information 610 and the corresponding two-dimensional code, visibility of the relationship between the link information and the two-dimensional code can be further enhanced.

If the print target data containing more than two pieces of link information is printed, the printing process may be executed for each of the pieces of link information. The print target data may be printed such that different colors are assigned to two-dimensional codes or different symbols are added to two-dimensional codes depending on the types of the two dimensional codes (i.e., depending on whether a two-dimensional code contains user information). In this case, the user is able recognize the two-dimensional code containing the user information at a glance. Therefore, it is possible to prevent the user from transmitting erroneously data containing the user information. That is, it is possible to prevent the access based on the two-dimensional code containing the user information.

As described above, in this embodiment, the two-dimensional code is generated in step S335 or S345, and only the two-dimensional code meeting the criterion is printed. However, the two-dimensional code maybe generated in step S360, S365, S410 and S415 after the criterion defining execution of print of the two-dimensional code so that only necessary two-dimensional codes are generated, thereby reducing the time for generating two-dimensional codes in a low amount of memory.

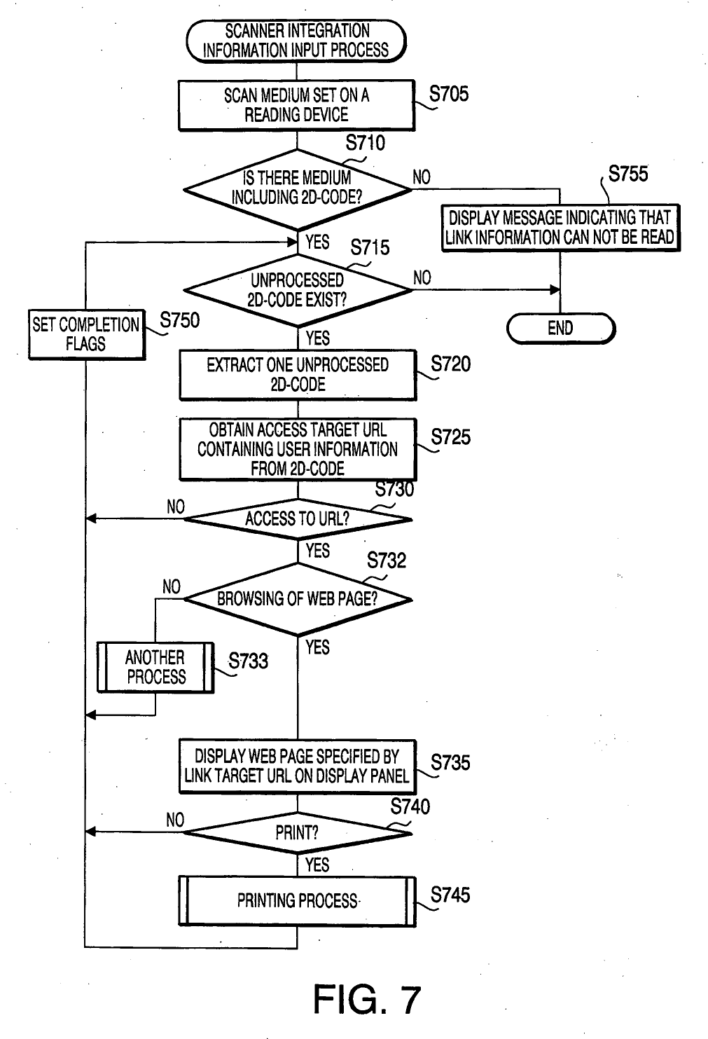

Hereafter, the scanner integration information input process executed in step S235 is described with reference to FIG. 7. The scanner integration information input process is executed under control o the control unit 200 of the MFP 20. In the scanner integration information input process, the two-dimensional code generated and printed in the printing process is read and access to an external server is attained.

First, the control unit 200 causes the reading unit 204 to read a print medium placed on a reading surface of the reading unit 204 and store the read image in the storage unit 202 (step S705). Then, the control unit 200 judges whether the read image (the print medium) contains a two-dimensional code (step S710). If a two-dimensional code is not contained in the read image (S710: NO), the control nit 200 displays a message indicating that a URL of an access target can not be read on the display unit 218 (step S755). Then, the scanner integration information input process terminates, and control returns to step S205 to wait for an instruction.

The control unit 200 is able to check whether a two-dimensional code is contained in the print medium by subjecting the read image stored in the storage unit 220 to the process in step S355 or S455. A normal reading process may be executed between steps S710 and S755.

If a two-dimensional code is contained in the read image (S710: YES), control proceeds to step S715. By the following steps, a two-dimensional code containing a desired link target can be read from the print medium even if the print medium contains more than two two-dimensional codes. In step S715, the control unit 200 judges whether an unprocessed two-dimensional code is contained in the read image. If all of the two-dimensional codes have been read and link targets have been accessed (S715: NO), the scanner integration information input process terminates.

If unprocessed two-dimensional codes remain in the read image (S715: YES), the control unit 200 extracts one of the unprocessed two-dimensional codes (step S720), and obtains a link target URL containing user information from the extracted two-dimensional code (step S725). In this case, if the two-dimensional code is generated in step S335, only a link taret URL is obtained from the two-dimensional code because such a two-dimensional code does not contain user information.

In step S730, the control unit 200 requests the user to judge whether access to the obtained URL should be performed. If the control unit judges that the user decided not to perform access to the obtained URL in accordance with a user operation through the operation unit 216 (730: NO), the control unit 200 assigns a completion flag to the two-dimensional code (step S750). Then, control returns to step S715.

In step S730, the control unit 200 may display the link target URL together with an inquiry message. In this case, the user is able to estimate a link target from the URL, and therefore access to an undesirable link target can be prevented from being wastefully executed. By setting the completion flag in step S750, the control unit 200 is able to recognize the processed two-dimensional code in step S715.

If the control unit 200 judges that the user decided to perform access to the obtained URL (S730: YES), control proceeds to step S732 where the control unit 200 judges whether the access target is a web page. If the access target is not a web page (S732: NO), control proceeds to step S733 where the control unit 200 executes another process. For example, update of firmware or uploading of data is executed in step S733. Then, control proceeds to step S′50 where the control unit assigns a completion flag to the two-dimensional code. Then, control returns to step S715.

If the link target is a web page (S732: YES), the control unit 200 accesses the link target and transmits the user information to the URL, and then displays the obtained web page and relevant information on the display unit 218 (step S735). Then, the control unit 200 request the user to judge whether the information displayed in step S735 should be printed (step S740). If the control unit 200 judges that the information should not be printed in accordance with a user operation through the control unit 216 (S740: NO), the control unit 200 assigns a completion flag to the two-dimensional code (step S′50). Then, control returns to step S715.

If the displayed information should be printed (S740: YES), the control unit 200 executes the above mentioned printing process (step S745).

In steps S720 to S750 where more than two two-dimensional codes exist in the print medium and a desired link target is found out from unprocessed two-dimensional codes, the scanner integration information input process is finished after all of the two-dimensional codes have been processed. However, the scanner integration information input process may be terminated when the desired link is found out. Such an operation is attained, for example, by inserting a judgment step for judging whether a desired link is obtained between steps S715 and S720 so that the scanner integration information input process terminates if the desired link is obtained, and that control proceeds to step S720 if the desired link is not obtained.

By this configuration, steps to be processed after the desired link is found out can be omitted, thereby decreasing the number of times where undesired link information is obtained.

The image read in step S705 may be displayed on the display unit 218 so that a location of a desired two-dimensional code is specified by the user through the operation unit 218 and the two-dimensional code of the specified location is read.

With this configuration, access to the undesired link can be prevented from wastefully executed, thereby allowing the user to easily reach the desired link target.

For example, if user information is “kumiko” and a link URL is “http://www.∘∘∘∘.jp/”, ink information is a URL “http://www.∘∘∘∘.co.jp/reg-kumiko”. In this case, the link target server receives the user information. Link information may be URL “http://click.ΔΔΔΔ.from.code-kumiko&adurl=http://www.∘∘∘∘.co.jp/”. In this case, the URL may be transferred from a server configured to only transfer the received URL to the link target server. Only user information may be transmitted separately from the link information.

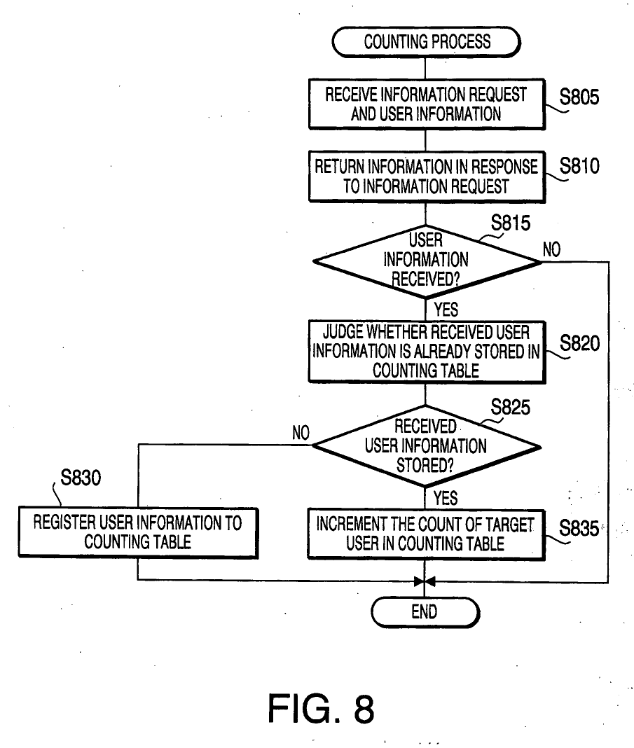

Hereafter, a counting process to be executed by the server 80 is described with reference to FIG. 8. The counting process is executed under control of the control unit 800 of the server 80 to collect user information.

First, the control unit 800 receives the user information together with a request for information based on the link information from the MFP 20, the PC 10 or the portable device 30 (step S805). Then, the control unit 800 transmits the requested information to a client (i.e., a requesting source) (step S810).

Next, the control unit 800 judges whether the data received in step S805 contains the user information (step S815). If the user information is not contained in the received data (S815: NO), the counting process terminates. If the user information is contained in the received data (S815: YES), the control unit 800 search a counting table in the storage unit 808 to judge whether the received user information has already stored in the counting table (step S820). Then, control proceeds to step S825.

If the received user information has not stored in the counting table (S825: NO), the control unit 800 newly registers the user information in the counting table (step S830). Then, the counting process terminates. If the received user information has already stored in the counting table (S825: YES), the control unit 200 increments the access count of the user information in the counting table (step S835). Then, the counting process terminates.

By this configuration, the server 80 is able to know which printing system accesses the server 80. In addition, the server 80 is able to know which of two-dimensional codes causes a lot of access to the server 80 by incrementing the access count each time access is caused for each of pieces of user information in the counting table.

As described above, according to the embodiment, it is possible to print out an image corresponding to print data together with a two-dimensional code containing a link target address corresponding to the link information and identification information identifying a print system that printed the print data.

By reading the printed image through a reading unit provided in a print system or a device (e.g., a portable device), it is possible to easily access a desired link target while transmitting the user information to a server.

The server which received the user information is able to know the access count corresponding to access based on a particular two-dimensional code by counting the access based on a two-dimensional code for each of pieces of user information in the counting table.

It is possible to form an affiliate system based on the embodiment. The affiliate system based on the embodiment enables a provider of advertisement to know information concerning a user who printed the advertisement of the provider. Therefore, benefits can be provided for the user who presented a company's web site to a person by printing out the web site using the user's printing device (i.e., using the user's consumable items such as ink and sheets of paper).

What is claimed is:

1. A printing system, comprising:
a detection unit configured to search first data to detect link address information representing a link target address linked to second data;
a storage unit that stores identification information identifying the printing system;
an image code generation unit configured to generate an image code representing link information containing the link address information detected by the detection unit and the identification information obtained from the storage unit; and
a print control unit configured to print the image code generated by the image code generation unit together with an image corresponding to the first data.

2. The printing system according to claim 1, wherein the print control unit prints the image code and the image of the first data such that the image code is arranged alongside the link address information.

3. The printing system according to claim 1, wherein:
the link address information in the first data includes a plurality of link target addresses linked to different types of second data; and
the image code generation unit generates a plurality of image codes respectively corresponding to a plurality of types of link information which respectively contain the plurality of link target addresses and the identification information.

4. The printing system according to claim 3, wherein the print control unit prints the image codes and the image of the first data such that the image codes are arranged in a cluster.

5. A printing system, comprising:
a detection unit configured to search first data to detect link address information representing a link target address linked to second data;
a storage unit that stores identification information identifying a user of the printing system;
an image code generation unit configured to generate an image code representing link information containing the link address information detected by the detection unit and the identification information obtained from the storage unit; and
a print control unit configured to print the image code generated by the image code generation unit together with an image corresponding to the first data.

6. An access source counting system, comprising:
a printing system; and
a server that provides contents to the printing system through a network,
wherein the printing system comprises:
a detection unit configured to search first data to detect link address information representing a link target address linked to second data;
a storage unit that stores identification information identifying the printing system;
an image code generation unit configured to generate an image code representing link information containing the link address information detected by the detection unit and the identification information obtained from the storage unit;
a print control unit configured to print the image code generated by the image code generation unit together with an image corresponding to the first data;
a reading unit configured to read the code mage from a printing medium on which the image corresponding to the first data and the image code are printed;
a link information acquisition unit configured to acquire the link information from the image code read by the reading unit;
an accessing unit configured to access the link target address in accordance with the link information acquired by the link information acquisition unit; and
an identification information transmission unit configured to transmit the identification information to the access target address in response to access to the link target address by the accessing unit,
wherein the server comprises:
an identification information reception unit configured to receive the identification information transmitted from the identification information transmission unit; and
a content providing unit configured to provide contents in accordance with the access from the accessing unit of the printing system.

7. The access source counting system according to claim 6, wherein the server further comprises a counting unit configured to count the number of accesses from the printing system in accordance with receipt of the identification information from the printing system.

8. An access source counting system, comprising:
a printing system; and
a server that provides contents to the printing system through a network,
wherein the printing system comprises:
a detection unit configured to search first data to detect link address information representing a link target address linked to second data;
a storage unit that stores identification information identifying a user of the printing system;
an image code generation unit configured to generate an image code representing link information containing the link address information detected by the detection unit and the identification information obtained from the storage unit;
a print control unit configured to print the image code generated by the image code generation unit together with an image corresponding to the first data;
a reading unit configured to read the code mage from a printing medium on which the image corresponding to the first data and the image code are printed;
a link information acquisition unit configured to acquire the link information from the image code read by the reading unit;
an accessing unit configured to access the link target address in accordance with the link information acquired by the link information acquisition unit; and
an identification information transmission unit configured to transmit the identification information to the access target address in response to access to the link target address by the accessing unit,
wherein the server comprises:
an identification information reception unit configured to receive the identification information transmitted from the identification information transmission unit; and
a content providing unit configured to provide contents in accordance with the access from the accessing unit of the printing system.

9. A computer readable medium having computer readable instructions stored thereon, which, when executed by a computer, are configured to:
search first data to detect link address information representing a link target address linked to second data;
store identification information identifying the printing system;
generate an image code representing link information containing the detected link address information and the stored identification information; and
control a print unit to print the image code together with an image corresponding to the first data.

10. A computer readable medium having computer readable instructions stored thereon, which, when executed by a computer, are configured to:
search first data to detect link address information representing a link target address linked to second data;
store identification information identifying a user of the printing system;
generate an image code representing link information containing the detected link address information and the stored identification information; and
control a print unit to print the image code together with an image corresponding to the first data.
